(19) United States
(12) Patent Application Publication
(10) Pub. No.: US 2007/0177096 A1
(43) Pub. Date: Aug. 2, 2007

(54) LIQUID CRYSTAL DISPLAY

(75) Inventors: Tatsuo UCHIDA, Miyagi-ken (JP); Takahiro Ishinabe, Miyagi-ken (JP); Mitsuo Oizumi, Fukushima-ken (JP); Mitsuru Kano, Fukushima-ken (JP); Yuzo Hayashi, Fukushima-ken (JP)

Correspondence Address: BRINKS HOFER GILSON & LIONE, P.O. BOX 10395, CHICAGO, IL, 60610, US

(73) Assignees: TOHOKU UNIVERSITY, Miyagi (JP); ALPS ELECTRIC CO., LTD., Tokyo (JP)

(21) Appl. No.: 11/668,968

(22) Filed: Jan. 30, 2007

(30) Foreign Application Priority Data
Jan. 30, 2006 (JP) 2006-020461
Jan. 30, 2006 (JP) 2006-020462

(51) Int. Cl. C09K 19/02

(52) U.S. Cl. 349/177

(57) ABSTRACT

A liquid crystal display is provided. The liquid crystal display includes a pair of substrates. The pair of substrates are disposed opposite to each other, having electrodes disposed above the opposed faces of the substrates. A nematic liquid crystal layer is disposed between the substrates and has a positive dielectric anisotropy. The electrodes are disposed above at least one of the substrates have slits. The centers of the slits are displaced from the centers of the electrodes disposed above the other substrate.

This patent document claims the benefit of Japanese Patent Application No. JP2006-020461 filed on Jan. 30, 2006 and JP2006-020462 filed on Jan. 30, 2006, which are hereby incorporated by reference.

### BACKGROUND

1. Field

The present embodiments relate to a liquid crystal display, having a wide viewing angle and a high response speed, for displaying a bright image.

2. Related Art

In recent years, liquid crystal displays (LCDs) have been widely used for display sections for personal computers, car navigation systems, digital still cameras, digital video cameras, mobile phones, liquid crystal televisions, and personal data assistants. The LCDs have a narrower viewing angle as compared to cathode-ray tube (CRT) displays and therefore need to be improved in viewing angle.

Japanese Patent No. 3108768 (hereinafter referred to as Patent Document 1) discloses a technique for increasing the viewing angle. In the technique, openings (slits) are formed in a display region located between a pair of electrodes, opposed to each other, included in a twisted nematic (TN)-mode LCD. The longitudinal direction of the slits is perpendicular to the alignment direction of liquid crystal molecules in an initial state (a voltage-free state).

Japanese Patent No. 2565639 (hereinafter referred to as Patent Document 2) discloses another technique (a multi-domain vertical alignment (MVA) mode) for increasing the viewing angle. In this technique, electrodes are disposed between a pair of electrode substrates, opposed to each other, included in a vertical alignment (VA) mode LCD, one of the electrodes (for example, a common electrode) has an area greater than that of the other one when viewed from above, and an opening or a slit is formed in an electrode disposed in a display region such that a transverse electric field is generated.

Viewing angle properties of the TN-mode LCD can be slightly improved but are insufficient. Since a back flow has a serious influence on the electric field response of directors of liquid crystal molecules, there are problems that high-speed response cannot be achieved and the brightness of an image viewed from the front is sacrificed.

In MVA mode display, protruding structures are provided on a substrate. This complicates a process for manufacturing the MVA mode display to cause an increase in manufacturing cost. In order to prevent tone reversal, the transmittance of white display sections needs to be reduced. Hence, an increase in brightness leads to an increase in power consumption. The response speed of the MVA mode display, as well as the TN mode display, is limited because of the serious influence of the back flow.

### SUMMARY

In one exemplary embodiment a liquid crystal display is suitable for mobile use. The liquid crystal display has a wide viewing angle and a high response speed and can be manufactured at low cost.

In one embodiment, a liquid crystal display includes a pair of substrates which are opposed to each other and which have electrodes disposed above the opposed faces of the substrates and also includes a nematic liquid crystal layer which is disposed between the substrates and which has positive dielectric anisotropy. The electrodes disposed above at least one of the substrates have slits and the centers of the slits are displaced from the centers of the electrodes disposed above the other substrate.

In the liquid crystal display, the slits may have a width greater than or equal to the cell gap.

According to the above configuration, the influence of the pre-tilt angle on display can be reduced and therefore the liquid crystal display has a wide viewing angle and a high response speed and can display a bright image. Unlike a vertical alignment type, the liquid crystal display has a simple structure and therefore can be manufactured at low cost.

In the liquid crystal display, the longitudinal direction of the slits is preferably substantially perpendicular to the direction in which average liquid crystal molecules are aligned in a voltage-free state.

In the liquid crystal display, at least one of the slits is preferably present per about 10d, wherein d represents the cell gap.

In the liquid crystal display, liquid crystal molecules contained in the nematic liquid crystal layer are preferably homogeneously aligned with respect to the faces of the substrates in a voltage-free state. The homogeneous alignment is preferably achieved in such a manner that rubbing is performed such that the liquid crystal molecules make a predetermined pre-tilt angle with the faces of the substrates. The pre-tilt angle is preferably less than about five degrees and more preferably about one to four degrees.

In the liquid crystal display, the centers of the slits are preferably displaced from the centers of the electrodes disposed above the other substrate by about d/4 to 2d when the pre-tilt angle is less than about four degrees, wherein d represents the cell gap.

In the liquid crystal display, the inequality d≦D≦2.5d is preferably satisfied, wherein D represents the width of the slits and d represents the cell gap.

In the liquid crystal display, the longitudinal direction of the slits is preferably substantially perpendicular to the direction in which average liquid crystal molecules are aligned in a voltage-free state.

In the liquid crystal display, at least one of the slits is preferably present per about 10d, wherein d represents the cell gap.

In the liquid crystal display, liquid crystal molecules contained in the nematic liquid crystal layer are preferably homogeneously aligned with respect to the faces of the substrates in a voltage-free state. The homogeneous alignment is preferably achieved in such a manner that rubbing is performed such that the liquid crystal molecules make a predetermined pre-tilt angle with the faces of the substrates. The pre-tilt angle is preferably less than about five degrees and more preferably about one to four degrees.

In the liquid crystal display, the centers of the slits are preferably displaced from the centers of the electrodes disposed above the other substrate by about d/4 to 2d when the pre-tilt angle is less than about four degrees, wherein d represents the cell gap.

In the liquid crystal display, the nematic liquid crystal preferably has positive dielectric anisotropy.

The liquid crystal display preferably further includes active elements corresponding to display pixels. The liquid crystal display is preferably a transmissive or semi-transmissive type.

In one embodiment, since the liquid crystal display has the above configuration, the liquid crystal display has a wide viewing angle and can be manufactured at low cost. The liquid crystal display has a high response speed and therefore is suitable for mobile use.

### BRIEF DESCRIPTION OF THE DRAWINGS

FIG. 1 is a schematic view of one embodiment of a liquid crystal display;

FIGS. 2A and 2B are illustrations showing the operation principle of the liquid crystal display shown in FIG. 1;

FIGS. 3A to 3C are illustrations of the patterns of slits arranged in electrodes disposed above a pair of substrates included in liquid crystal displays;

FIGS. 4A to 4C are graphs showing the relationship between the observation angle and transmittance of liquid crystal display panels of Example 1;

FIGS. 5A and 5B are graphs showing the relationship between the observation angle and transmittance of other liquid crystal display panels of Example 1;

FIG. 6 is a graph showing the relationship between the observation angle and transmittance of a liquid crystal display panel used in Example 1 for comparison;

FIGS. 7A to 7D are graphs showing the relationship between the observation angle and transmittance of liquid crystal display panels of Example 2; and

FIG. 8 is a graph showing the relationship between the observation angle and transmittance of a liquid crystal display panel used in Example 2 for comparison.

### DETAILED DESCRIPTION

Exemplary embodiments will be described in detail with reference to the accompanying drawings.

The present embodiments may be applied to transmissive liquid crystal displays that display images using transmitted light emitted from lighting devices such as backlights and also applied to semi-transmissive liquid crystal displays that display images using reflected external light and transmitted light emitted from lighting devices such as backlights.

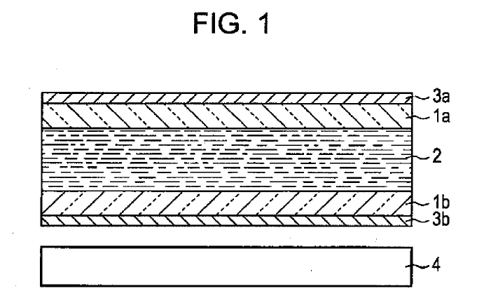

FIG. 1 is a schematic view of a liquid crystal display according to one embodiment. The liquid crystal display shown in FIG. 1 is a transmissive type and includes a liquid crystal panel, a first polarizing film 3a, a second polarizing film 3b, and a backlight 4. The liquid crystal panel includes a transparent substrate 1a, an active matrix substrate 1b opposed to the transparent substrate 1a, and a liquid crystal layer 2 sandwiched between the transparent substrate 1a and the active matrix substrate 1b. The first and second polarizing films 3a and 3b are disposed on outer faces of the transparent substrate 1a and the active matrix substrate 1b, respectively. The backlight 4 is located outside the liquid crystal panel, for example, the backlight 4 is located below the second polarizing film 3b as shown in FIG. 1.

A transparent electrode (common electrode) is disposed above a principal face of the transparent substrate 1a that is directed to the liquid crystal layer 2. A first alignment layer (not shown) lies on the transparent electrode. Pixel electrodes and switching elements (active elements) corresponding to pixels are arranged above a principal face of the active matrix substrate 1b that is directed to the liquid crystal layer 2. A second alignment layer (not shown) extends over the switching elements and the pixel electrodes. Spacers (not shown) are arranged between the transparent substrate 1a and the active matrix substrate 1b such that the distance (cell gap) therebetween is maintained constant. The circumferential edge of the transparent substrate 1a is joined to that of the active matrix substrate 1b with a sealing member (not shown) in a sealed manner. The liquid crystal panel further includes red, green, and blue color filters (not shown) each corresponding to one sub-pixel and therefore can display a color image. The transparent substrate 1a and the active matrix substrate 1b are made of glass. The pixel electrodes are made of a transparent material such as indium tin oxide (ITO).

The liquid crystal layer 2 is disposed in a sealed space between the first and second alignment layers and contains a nematic liquid crystal having positive dielectric anisotropy. Molecules of the nematic liquid crystal are homogeneously arranged because of the presence of the first and second alignment layers such that the liquid crystal molecules are pre-tilted in a predetermined direction and have a twist angle of about zero degree. The pre-tilt direction or alignment direction of the liquid crystal molecules is set by arranging the first and second polarizing films 3a and 3b such that the transmittance is maximized during the application of a driving voltage.

The polarization directions of the first and second polarizing films 3a and 3b are set such that a black level is achieved when no driving voltage is applied to the liquid crystal layer 2. With reference to FIG. 1, optical elements are the first and second polarizing films 3a and 3b only. Other optical elements such as a ¼ wavelength film and an optical compensation film may be used as required.

The backlight 4 includes a light guide plate which is flat and transparent and which is made of an acrylic resin and also includes a light source such as a cathode fluorescent tube (CFT) or a light-emitting diode (LED). Light emitted from the light source is extracted through a face of the light guide plate and then applied to the liquid crystal panel.

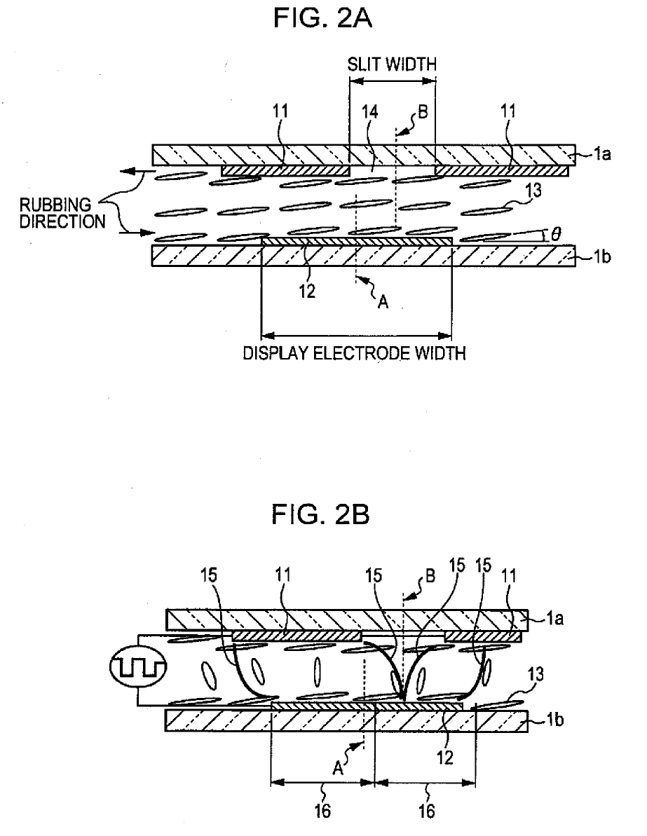

FIG. 2A shows the liquid crystal display in which no voltage is applied to the liquid crystal layer 2. FIG. 2B shows the liquid crystal display in which a voltage is applied to the liquid crystal layer 2. With reference to FIGS. 2A and 2B, a common electrode 11 is disposed under the transparent substrate 1a and display electrodes 12 are arranged above the active matrix substrate 1b. The first alignment layer extends over the common electrode 11 and the second alignment layer extends over the display electrodes 12. The first and second alignment layers are not shown in FIGS. 2A and 2B. The liquid crystal layer is sandwiched between the transparent substrate 1a and the active matrix substrate 1b. The liquid crystal molecules 13 are present in the liquid crystal layer. With reference to FIG. 2A, the first alignment layer is rubbed in the left direction in this figure and the second alignment layer is rubbed in the right direction in this figure; hence, the liquid crystal molecules 13 are arranged such that right portions of the liquid crystal molecules 13 are raised and therefore the liquid crystal molecules 13 have a pre-tilt angle. That is, the liquid crystal molecules 13 are homogeneously arranged with respect to the transparent substrate 1a and the active matrix substrate 1b. In consideration of homogeneous alignment, the liquid crystal molecules 13 preferably have a pre-tilt angle θ of less than about five degrees and more preferably about one to four degrees.

The common electrode 11 has slits 14, which are arranged such that the centers B of the slits 14 are displaced from the centers A of the corresponding display electrodes 12. That is, the slits 14 are asymmetrical with the display electrodes 12 when viewed from above. The longitudinal direction of the slits 14 is substantially perpendicular to the alignment direction (the left direction in FIG. 2A) of the liquid crystal molecules 13 to which no voltage is applied as shown in FIG. 2A, that is, the longitudinal direction of the slits 14 is substantially normal to the plane of FIG. 2. The slits 14 preferably have a width of about 4 to 10 μm when the cell gap is 4 μm. This is because fringe electric fields having transverse components capable of improving viewing angle properties can be generated, the influence caused by the liquid crystal molecules 13 which are located under center areas of the slits 14 and which are insensitive to an electric field can be reduced, or the aperture ratio can be prevented from being seriously reduced. In particular, the following inequality is preferably satisfied: d≦D≦2.5d, wherein D represents the width of the slits 14 and d represents the cell gap. The displacement of the center B of each slit 14 from the center A of each corresponding display electrode 12 will be described below in detail. In order to clearly show the pattern of the slits 14 arranged repeatedly, the slits 14 are shown in the accompanying drawings so as to be narrower than the cell gap.

As shown in FIG. 2B, the liquid crystal molecules 13 between the transparent substrate 1a and the active matrix substrate 1b are aligned along fringe electric fields 15 by the application of voltages between the common electrode 11 and the display electrodes 12. In two of domain regions 16 shown in FIG. 2B, the liquid crystal molecules 13 are aligned in substantially symmetrical directions. This allows an observer to view the same image in different directions. Therefore, the liquid crystal display has a wide viewing angle.

Unlike the liquid crystal molecules 13 vertically aligned, the liquid crystal molecules 13 homogeneously aligned are pre-tilted such that the liquid crystal molecules 13 can be readily raised. Since the liquid crystal molecules 13 are pre-tilted, the liquid crystal molecules 13 above the two domain regions 16 shown in FIG. 2B cannot be symmetrically raised only by the presence of the slits 14. Therefore, in this embodiment, the centers B of the slits 14 are displaced from the centers A of the corresponding display electrodes 12, whereby the misalignment between the liquid crystal molecules 13 is compensated when the pre-tilted liquid crystal molecules 13 are raised. This allows the liquid crystal molecules 13 above the two domain regions 16 to be symmetrically raised.

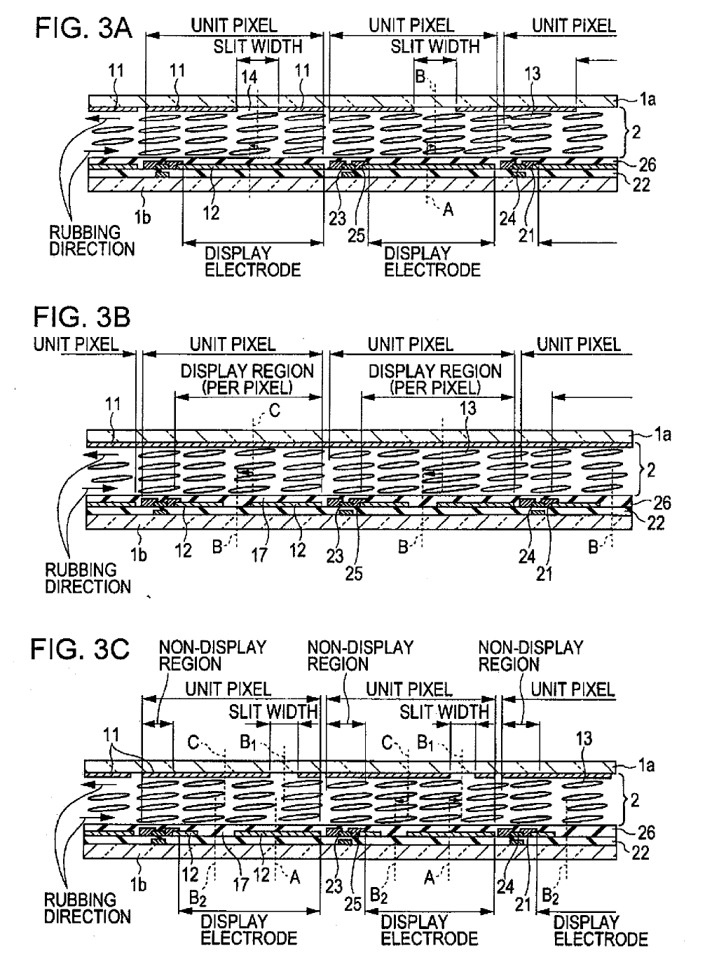

The direction in which the centers B of the slits 14 are displaced from the centers A of the corresponding display electrodes 12 is preferably coincident with the direction in which the liquid crystal molecules 13 are raised. In the liquid crystal display, since rubbing is performed in directions as shown in FIG. 2A, the liquid crystal molecules 13 above the active matrix substrate 1b are pre-tilted such that these liquid crystal molecules 13 are raised in the right direction in FIG. 2A. In this case, the centers B of the slits 14 are displaced rightward from the centers A of the corresponding display electrodes 12. In one embodiment, as shown in FIGS. 3A to 3C, liquid crystal displays each include a first substrate 1a, a second substrate 1b, and a liquid crystal layer 2 sandwiched between the first and second substrates 1a and 1b. With reference to FIG. 3A, 3B, or 3C, active elements, serving as switching elements, corresponding to pixels are arranged above the first substrate 1a and therefore slit patterns are formed in consideration of non-display regions and the like. In each liquid crystal display shown in FIG. 3A, 3B, or 3C, gates 21 are arranged above the second substrate 1b and covered with a first insulating layer 22. Semiconductor layers 23, sources 24, and drains 25 are arranged on the insulating layer 22 to form thin-film transistors (TFTs). The TFTs are covered with a second insulating layer 26. Each alignment layer (not shown) is disposed above or under a face of the first or second substrate 1a or 1b that is directed to the liquid crystal layer 2 and rubbed in a direction in FIG. 3A, 3B, or 3C.

The liquid crystal display shown in FIG. 3A further includes a common electrode 11 having slits 14 and display electrodes 12 arranged above the second substrate 1b. The number of the slits 14 is one per pixel. The centers B of the slits 14, as well as that described with reference to FIG. 2, are displaced rightward from the centers A of the corresponding display electrodes 12.

The liquid crystal display shown in FIG. 3B further includes a common electrode 11 disposed under the first substrate 1a and display electrodes 12, arranged above the second substrate 1b, having slits 17. The number of the slits 17 is one per pixel. The center B of each slit 17 is displaced rightward from the center C of each portion (a portion of each display region corresponding to one pixel) of the common electrode 11. With reference to FIG. 3B, liquid crystal molecules 13 have a pre-tilt angle such that the liquid crystal molecules 13 are raised in the right direction (the left direction when viewed from the opposite side of this figure) in this figure when viewed from the first substrate 1a. The center B of the slit 17 is displaced rightward (leftward when viewed from the opposite side of FIG. 3B) from the center C of the portion of the common electrode 11 as shown in FIG. 3B. The direction in which the slits 17 are displaced is coincident with the direction in which the liquid crystal molecules 13 are raised.

The liquid crystal display shown in FIG. 3C further includes a common electrode 11, disposed under the first substrate 1a, having slits 14 and display electrodes 12, arranged above the second substrate 1b, having slits 17. The number of the slits 14 of the first substrate 1a is one per pixel and the number of the slits 17 of the second substrate 1b is one per pixel. That is, one pixel corresponds to one slit 14 and one slit 17. The center B1 of each slit 14 is displaced rightward from the center A of each corresponding display electrode 12. The center B2 of each slit 17 is displaced leftward from the center C (the center of one unit pixel region) of each corresponding portion (a portion of each display region corresponding to one pixel) of the common electrode 11. With reference to FIG. 3C, liquid crystal molecules 13 have a pre-tilt angle such that the liquid crystal molecules 13 are raised in the right direction (the left direction when viewed from the opposite side of this figure) in this figure when viewed from the first substrate 1a. The center B2 of the slit 17 is displaced rightward (leftward when viewed from the opposite side of FIG. 3C) from the center C of the portion of the common electrode 11 as shown in FIG. 3C. The direction in which the slits 17 are displaced is coincident with the direction in which the liquid crystal molecules 13 are raised.

In the liquid crystal displays of these embodiments, at least one of the slits 14 and/or 17 is preferably present per about 10d in consideration of improvement in viewing angle, wherein d represents the cell gap. The following equation is preferably satisfied: d≦D≦2.5d, wherein D represents the width of the slits 14 and 17 and d represents the cell gap. This is because fringe electric fields having transverse components capable of improving viewing angle properties can be generated, the influence caused by the liquid crystal molecules 13 which are located above or under center areas of the slits 14 or 17 and which are insensitive to an electric field can be reduced, or the aperture ratio can be prevented from being seriously reduced. In order to clear show the pattern of the slits 14 or 17 arranged repeatedly, the slits 14 or 17 are shown in these figures so as to be narrower than the cell gap.

The following displacement is preferably about 1 to 15 μm and more preferably about 2 to 10 μm: the displacement of the center B, B1, or B2 of each slit 14 or 17 from the center A of each display electrode 12 or the center C of the portion of each common electrode 11. This is because the light transmittance distribution depends on the distribution of the liquid crystal molecules 13 that are raised from the surfaces of the first and second substrates 1a and 1b by the effect of an electric field (including the effect of a fringe electric field) in the opposite directions with respect to the pre-tilt angle thereof. When the pre-tilt angle is less than four degrees, the displacement thereof is preferably about d/4 to 2d, wherein d represents the cell gap. When the pre-tilt angle exceeds four degrees, the displacement is likely to be large and therefore needs to be optimized.

### EXAMPLES

In order to illustrate advantages of the present embodiments, examples will be described.

### Example 1

A common electrode 11 having slits 14 was formed above a first substrate. A first alignment layer was formed above the common electrode 11 and then rubbed in the right direction as shown in FIG. 2A. Display electrodes 12 were formed over a second substrate. A second alignment layer was formed over the display electrodes 12 and then rubbed in the left direction in FIG. 2A. The first and second substrates were spaced from each other at a predetermined distance such that the first and second alignment layers were opposed to each other.

A nematic liquid crystal having positive dielectric anisotropy was injected into a space between the first and second substrates and the space was then sealed. The above procedure was repeated, whereby five liquid crystal display panels were prepared. The liquid crystal display panels were different from each other in that the arrangements of the slits 14 were different from each other. The liquid crystal display panels included color filters so as to display color images. The slits 14 had a width of about 5 μm, the liquid crystal display panels had a cell gap of about 4.2 μm, and molecules of the liquid crystal had a pre-tilt angle of about one degree. The liquid crystal molecules, which are not shown, were aligned such that the liquid crystal molecules were raised in the right direction in FIG. 2A.

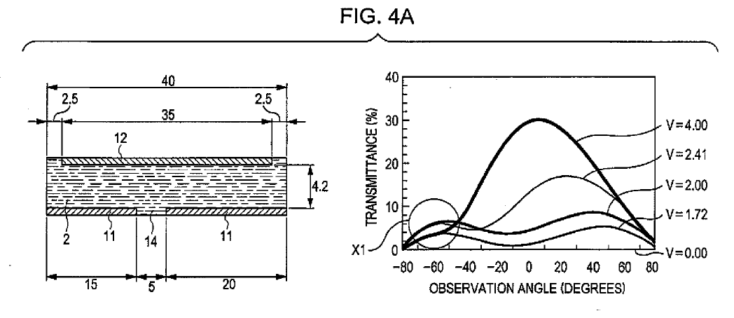

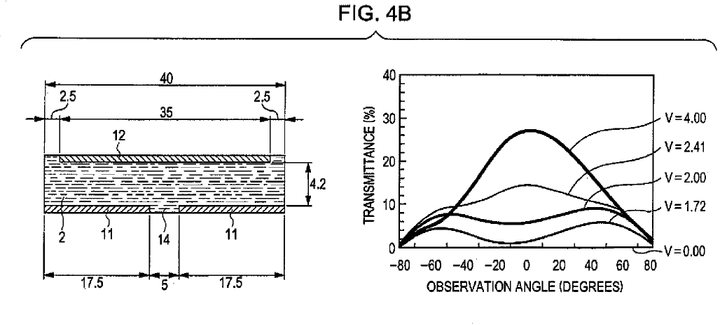

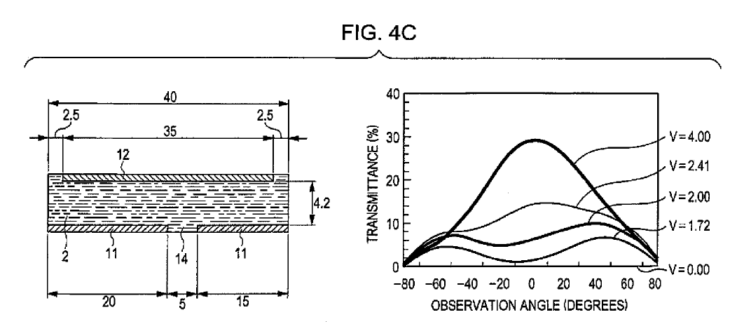

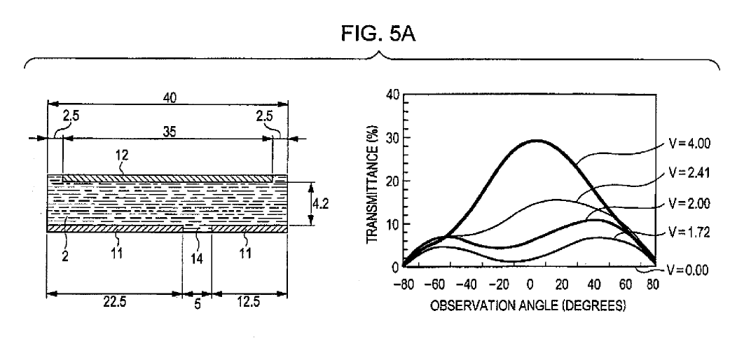

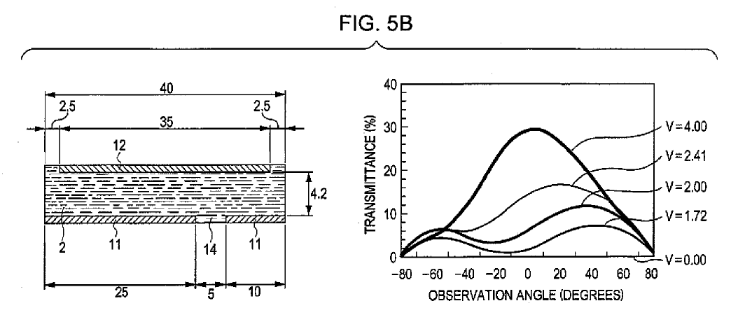

The liquid crystal display panels were measured for observation angle and transmittance using an LCD simulator available from Shintech Inc. Obtained results are shown in FIGS. 4A to 4C and FIGS. 5A and 5B.

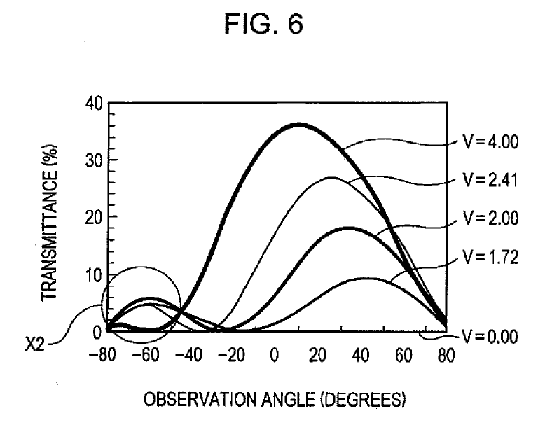

A liquid crystal display panel, including a common electrode having no slit, for comparison was prepared and then measured for observation angle and transmittance. Obtained results are shown in FIG. 6.

In the liquid crystal display panel shown in FIG. 4A, the centers of the slits 14 were displaced from the centers of the corresponding display electrodes 12 by about 2.5 μm in the direction opposite to the direction in which the liquid crystal molecules were raised. In the liquid crystal display panel shown in FIG. 4B, the centers of the slits 14 were not displaced from the centers of the corresponding display electrodes 12. In the liquid crystal display panel shown in FIG. 4C, the centers of the slits 14 were displaced from the centers of the corresponding display electrodes 12 by about 2.5 μm in the direction in which the liquid crystal molecules were raised. In the liquid crystal display panel shown in FIG. 5A, the centers of the slits 14 were displaced from the centers of the corresponding display electrodes 12 by about 5 μm in the direction in which the liquid crystal molecules were raised. In the liquid crystal display panel shown in FIG. 5B, the centers of the slits 14 were displaced from the centers of the corresponding display electrodes 12 by about 7.5 μm in the direction in which the liquid crystal molecules were raised. In these figures, dimensions are shown in μm. These dimensions are for exemplification and should not be construed as limitative.

For the liquid crystal display panel having no slit, the following region is present in the graph shown in FIG. 6: Region X2 which ranges from an observation angle of about −80 degrees to an observation angle of about −40 degrees and which relates to tone reversal (a phenomenon that gray display (V=2.41, 2.00, or 1.72) is brighter than white display (V=4.00)). For those liquid crystal display panels having the slits 14, Regions X1 relating to tone reversal are present in the graphs shown in FIGS. 4A to 4C and 5A and 5B and are smaller than Regions X2. This illustrates that those liquid crystal display panels have a wide viewing angle and can display good images. As shown in FIGS. 4A, 4C, 5A, and 5B, the liquid crystal display panels having the slits 14 of which the centers are displaced from the centers of the corresponding display electrodes 12 have a relatively large transmittance; hence, these liquid crystal display panels can display bright images. As shown in FIGS. 4C, 5A, and 5B, in the liquid crystal display panels having the slits 14 of which the centers are displaced from the centers of the corresponding display electrodes 12 in the direction in which the liquid crystal molecules are raised, tone reversal is slight. This illustrates that these liquid crystal display panels have a wide viewing angle and can display good images. Furthermore, as shown in FIGS. 5A and 5B, the liquid crystal display panels having the slits 14 of which the centers are displaced from the centers of the corresponding display electrodes 12 by 5 or 10 μm are good in symmetry on observation angle for each color. This illustrates that these liquid crystal display panels are uniformly bright when viewed at the same observation angle in any direction.

The liquid crystal display panel shown in FIG. 4C and a liquid crystal display panel, including a vertically oriented liquid crystal layer, for comparison were compared to each other for transmittance on the assumption that these liquid crystal display panels have an NTSC ratio of about 60% and an aperture of about 50%. In the liquid crystal display panel shown in FIG. 4C, the percentage of a display area was about 86% and the transmittance was 4.5. In the liquid crystal display panel including the vertically oriented liquid crystal layer, the percentage of a display area was about 62% and the transmittance was 3.6. This illustrates that the liquid crystal display panel shown in FIG. 4C can display a brighter image as compared to the liquid crystal display panel including the vertically oriented liquid crystal layer.

Since the liquid crystal display panels of this example include the display electrodes 12 and the common electrodes 11 having the slits 14 and the centers of the slit 14 are displaced from the centers of the corresponding display electrodes 12, the influence of the pre-tilt angle on display can be reduced. Hence, these liquid crystal display panels have a wide viewing angle and a high response speed and therefore can display bright images. Unlike the liquid crystal display panel including the vertically oriented liquid crystal layer, these liquid crystal display panels have a simple structure and therefore can be manufactured at low cost.

### Example 2

In the same manner as that described in Example 1, a common electrode 11 having slits 14 was formed above a first substrate and a first alignment layer was formed above the common electrode 11 and then rubbed in the right direction as shown in FIG. 2A. Display electrodes 12 were formed over a second substrate. A second alignment layer was formed over the display electrodes 12 and then rubbed in the left direction in FIG. 2A. The first and second substrates were spaced from each other at a predetermined distance such that the first and second alignment layers were opposed to each other. A nematic liquid crystal having positive dielectric anisotropy was injected into a space between the first and second substrates and the space was then sealed. The above procedure was repeated, whereby four liquid crystal display panels were prepared. The liquid crystal display panels were different in slit width from each other. The liquid crystal display panels included color filters so as to display color images. The liquid crystal display panels had a cell gap of about 4.2 μm, molecules of the liquid crystal had a pre-tilt angle of about one degree, and the centers of the slit 14 were displaced from the centers of the corresponding display electrodes 12 by about 2.5 μm in the direction in which the liquid crystal molecules were raised. The liquid crystal molecules, which are not shown, were aligned such that the liquid crystal molecules were raised in the right direction in FIG. 2A.

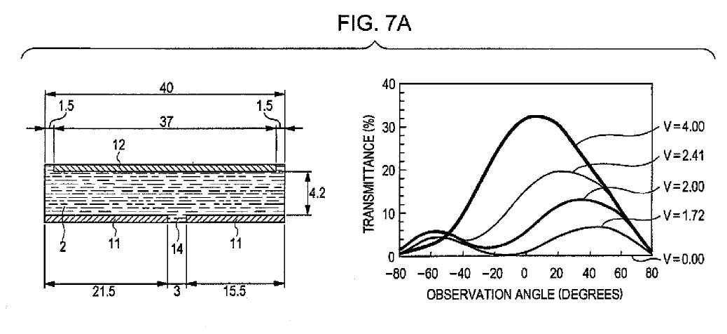

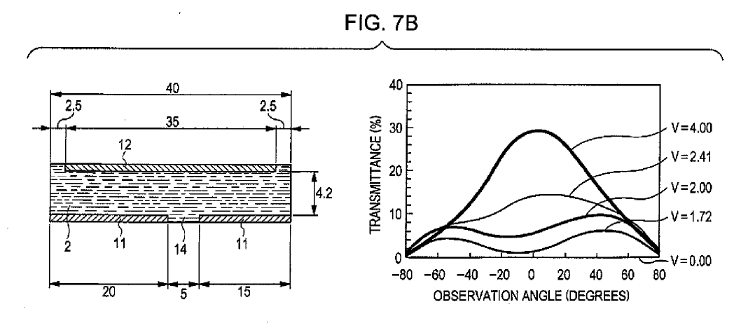

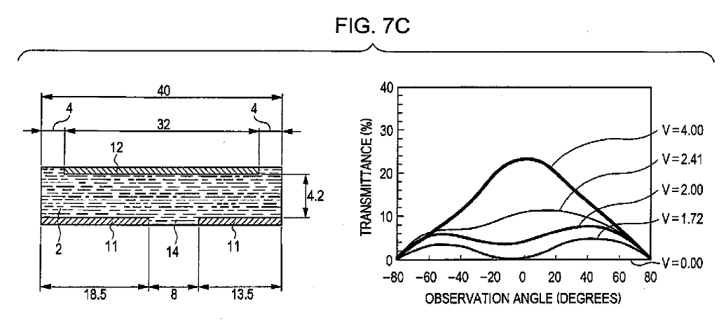

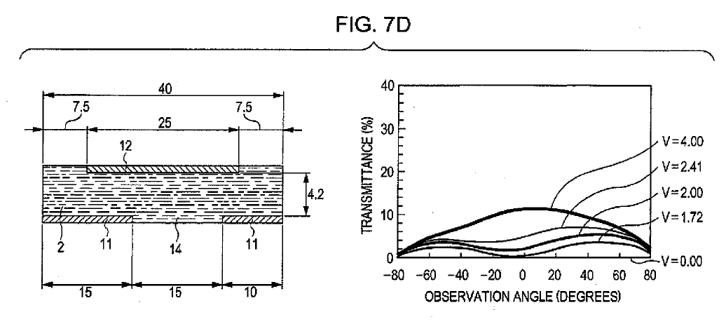

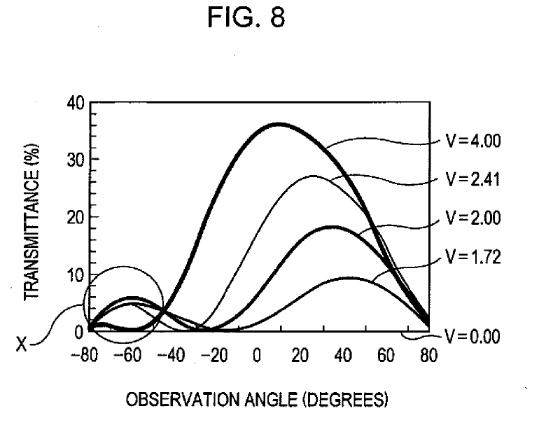

The liquid crystal display panels were measured for observation angle and transmittance using the LCD simulator available from Shintech Inc. in the same manner as that described in Example 1. Obtained results are shown in FIGS. 7A to 7D. A liquid crystal display panel, including a common electrode having no slit, for comparison was prepared and then measured for observation angle and transmittance. Obtained results are shown in FIG. 8. The liquid crystal display panel shown in FIG. 7A had a slit width of about 3 μm. The liquid crystal display panel shown in FIG. 7B had a slit width of about 5 μm. The liquid crystal display panel shown in FIG. 7C had a slit width of about 8 μm. The liquid crystal display panel shown in FIG. 7D had a slit width of about 15 μm. In these figures, dimensions are shown in μm. These dimensions are for exemplification and should not be construed as limitative.

The liquid crystal display panels shown in FIG. 7A to 7D are slighter in tone reversal as compared to the liquid crystal display panel, shown in FIG. 8, having no slit. This illustrates that the liquid crystal display panels shown in FIG. 7A to 7D have a wide viewing angle and can display good images. Furthermore, as shown in FIGS. 7A to 7D, since the centers of the slits 14 are displaced from the centers of the corresponding display electrodes 12 and the slit width is greater than the cell gap, these liquid crystal display panels are good in symmetry on observation angle for each color. This illustrates that these liquid crystal display panels are uniformly bright when viewed at the same observation angle in any direction.

The liquid crystal display panel shown in FIG. 7B and a liquid crystal display panel, including a vertically oriented liquid crystal layer, for comparison were compared to each other for transmittance on the assumption that these liquid crystal display panels have an NTSC ratio of about 60% and an aperture of about 50%. In the liquid crystal display panel shown in FIG. 7B, the percentage of a display area was about 86% and the transmittance was 4.5. In the liquid crystal display panel including the vertically oriented liquid crystal layer, the percentage of a display area was about 62% and the transmittance was 3.6. This illustrates that the liquid crystal display panel shown in FIG. 7B can display a brighter image as compared to the liquid crystal display panel including the vertically oriented liquid crystal layer.

In the liquid crystal display panels of this example, the common electrodes 11 have the slits 14, the centers of the slit 14 are displaced from the centers of the corresponding display electrodes 12, and the slit width is greater than the cell gap. Hence, these liquid crystal display panels have a wide viewing angle and a high response speed and therefore can display bright images. Unlike the liquid crystal display panel including the vertically oriented liquid crystal layer, these liquid crystal display panels have a simple structure and therefore can be manufactured at low cost.

The present invention is not limited to the above embodiments. Although the liquid crystal displays described in the embodiments are an active matrix type, the present invention can be applied to passive matrix-type liquid crystal displays. Values, materials, and display configurations described in the embodiments are not particularly limited. Modifications may be made within the scope of the present invention.

1. A liquid crystal display comprising:
a pair of substrates, disposed opposite to each other, having electrodes disposed above faces of the substrates; and
a nematic liquid crystal layer, disposed between the substrates, having positive dielectric anisotropy,
wherein the electrodes disposed above at least one of the substrates have slits and the centers of the slits are displaced from the centers of the electrodes disposed above the other substrate.

2. The liquid crystal display according to claim 1, wherein a longitudinal direction of the slits is substantially perpendicular to a direction in which average liquid crystal molecules are aligned in a voltage-free state.

3. The liquid crystal display according to claim 1, wherein at least one of the slits is present per about 10d, where d represents the cell gap.

4. The liquid crystal display according to claim 1, wherein liquid crystal molecules contained in the nematic liquid crystal layer are homogeneously aligned with respect to the faces of the substrates in a voltage-free state.

5. The liquid crystal display according to claim 4, wherein the homogeneous alignment is achieved by a rubbing that is performed such that the liquid crystal molecules make a predetermined pre-tilt angle with the faces of the substrates.

6. The liquid crystal display according to claim 5, wherein the pre-tilt angle is less than about five degrees.

7. The liquid crystal display according to claim 6, wherein the pre-tilt angle is about one to four degrees.

8. The liquid crystal display according to claim 5, wherein the centers of the slits are displaced from the centers of the electrodes disposed above the other substrate by about d/4 to 2d when the pre-tilt angle is less than about four degrees, where d represents the cell gap.

9. The liquid crystal display according to claim 1, further comprising active elements corresponding to display pixels.

10. The liquid crystal display according to claim 1, wherein the liquid crystal display is a transmissive or semi-transmissive type.

11. A liquid crystal display comprising:
a pair of substrates, disposed opposite to each other, having electrodes disposed above the opposed faces of the substrates; and
a nematic liquid crystal layer, disposed between the substrates, having positive dielectric anisotropy,
wherein the electrodes disposed above at least one of the substrates have slits, the centers of the slits are displaced from the centers of the electrodes disposed above the other substrate, and the slits have a width greater than or equal to the cell gap.

12. The liquid crystal display according to claim 11, wherein d≦D≦2.5d is satisfied, where D represents the width of the slits and d represents the cell gap.

13. The liquid crystal display according to claim 11, wherein a longitudinal direction of the slits is substantially perpendicular to a direction in which average liquid crystal molecules are aligned in a voltage-free state.

14. The liquid crystal display according to claim 11, wherein at least one of the slits is present per about 10d, where d represents the cell gap.

15. The liquid crystal display according to claim 11, wherein liquid crystal molecules contained in the nematic liquid crystal layer are homogeneously aligned with respect to the faces of the substrates in a voltage-free state.

16. The liquid crystal display according to claim 15, wherein the homogeneous alignment is achieved in such a manner that rubbing is performed such that the liquid crystal molecules make a predetermined pre-tilt angle with the faces of the substrates.

17. The liquid crystal display according to claim 16, wherein the pre-tilt angle is less than about five degrees.

18. The liquid crystal display according to claim 17, wherein the pre-tilt angle is about one to four degrees.

19. The liquid crystal display according to claim 16, wherein the centers of the slits are displaced from the centers of the electrodes disposed above the other substrate by about d/4 to 2d when the pre-tilt angle is less than about four degrees, where d represents the cell gap.

20. The liquid crystal display according to claim 11, further comprising active elements corresponding to display pixels.

21. The liquid crystal display according to claim 11, wherein the liquid crystal display is a transmissive or semi-transmissive type.
